(19) United States
(12) Patent Application Publication
(10) Pub. No.: US 2008/0220885 A1
(43) Pub. Date: Sep. 11, 2008

(54) Non-Rigid Coupling for the Mutual Connection of Two Rotary Bodies, the Axes Thereof Being Inclined in Relation to Each Other

(75) Inventor: Francis Muchingile, Winhoring (DE)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(73) Assignee: SGF Suddeutsche Gelenkscheibenfabrik GmbH & Co. KG

(21) Appl. No.: 11/994,540

(22) PCT Filed: Jun. 27, 2006
(86) PCT No.: PCT/EP2006/006201

§ 371 Date: Apr. 10, 2008

(30) Foreign Application Priority Data
Jul. 6, 2005 (DE) 10 2005 031 641.7

(51) Int. Cl. F16D 3/00

(52) U.S. Cl. 464/98

(57) ABSTRACT

The coupling (10) has a flexible disk (12), that is arranged between two rotary bodies (34, 36). Linings (16) are embedded in the flexible disk (12) at regular intervals about a central axis (C), parallel to the same. Connection bodies (18), that are each surrounded by one of the linings (16) and can be displaced in a limited manner in relation thereto, can be fixed alternately to each of the rotary bodies (36, 38). The linings (16) respectively form a ball-and-socket joint (20) with the associated connection bodies (18). The flexible disk (12) contains two pairs of such diametrically opposed ball-and-socket joints (20). The two linings (16) of each pair of ball-and-socket joints (20) are interconnected by means of a rigid cross-member (26). The coupling (10) is able to transmit rotary movements between two rotary bodies (34, 36) in a reliable, accurate and essentially loss-free manner, when the axes of the rotary bodies are inclined in relation to each other at an angle of at least 15 degrees.

The invention relates to a non-rigid coupling for the mutual connection of two rotary bodies, the axes thereof being inclined in relation to each other, with

a flexible disk, which is arranged between the rotary bodies,

linings, which are embedded in the flexible disk at regular intervals about a central axis, parallel to the same, and

connection bodies, that are each surrounded by one of the linings and can be displaced in a limited manner in relation thereto, are each fixed alternately to one of the rotary bodies.

Such a non-rigid coupling is for example known from DE 195 31 201 A1. In this arrangement, it relates to a vibration-damping, torsionally flexible shaft joint, that is intended particularly for the drivetrain of motor vehicles. The linings embedded in the flexible disk are externally and internally cylindrical, and each of them surrounds at a radial distance a similarly cylindrical lining of smaller diameter, which is intended as a connection body. The space between each of the external linings embedded directly into the flexible disk and the internal lining surrounded by it is filled with rubber, against whose flexible resistance the internal linings can carry out limited translation movements in a peripheral direction as well as tilting movements in relation to the external linings surrounding them. This relative play of the internal linings contributes to vibration decoupling between the rotary bodies inter-connected by the flexible disk and permits small axis alignment errors between these rotary bodies to be compensated. However, in this arrangement, the axes of the rotary bodies may only be inclined towards each other by a small angle in the magnitude of approximately 1 to 3 degrees. Larger angles of inclination, such as are found, for example, in steering drives of motor vehicles, cannot be achieved solely with known non-rigid couplings of the species mentioned at the outset; such couplings must therefore be combined with additional joints, usually cross pin joints, so that the required bending angle is produced in total. In this arrangement, however, the combining of a non-rigid coupling according to the species with a cross pin joint or similar is effectively a double joint, so that it is generally necessary to place at least one of the two rotary bodies concerned in an additional permanent bearing to safeguard against collapse.

The object of the invention is therefore to create a non-rigid coupling, that as such is able to transmit rotary movements between two rotary bodies inclined in relation to each other in a reliable, accurate and essentially loss-free manner, when the axes of the rotary bodies are inclined in relation to each other at an angle of two digits, preferably exceeding 15 degrees.

The object is achieved according to the invention starting with a non-rigid coupling of the species described at the outset, in that

the linings together with the associated connection body each form a ball-and-socket joint,

the flexible disk contains two pairs of such ball-and-socket joints, diametrically opposite each other, and

the two linings of each pair of ball-and-socket joints are connected to each other by means of a rigid cross-member.

The invention limits the ranges, in which the flexible disk warps when rotating the rotary bodies connected to each other by it. As a result, the angles of rotation of the two rotating bodies are more strictly correlated to each other, than was the case up till now when using known non-rigid couplings. Thus, for a given value of the torques to be transmitted and of the angle of inclination between the axes of the rotating bodies coupled together, the flexible disk is exposed to lower flexing loads, so that the hysteresis losses from to-and-fro movements of the rotating bodies typical in steering procedures are kept low and the flexible disk has a correspondingly longer life than previously. The coupling according to the invention does not require a larger structural space than a comparable known coupling according to the species as such; separate centering is also not necessary. Thus, the cost and space expenditure required up till now for a cross pin joint and centering can be avoided.

Advantageous improvements to the invention are to be found in the sub-claims. Further features of the invention will emerge from the following description of an embodiment and mounting arrangement, which is shown in the accompanying drawings, in which:

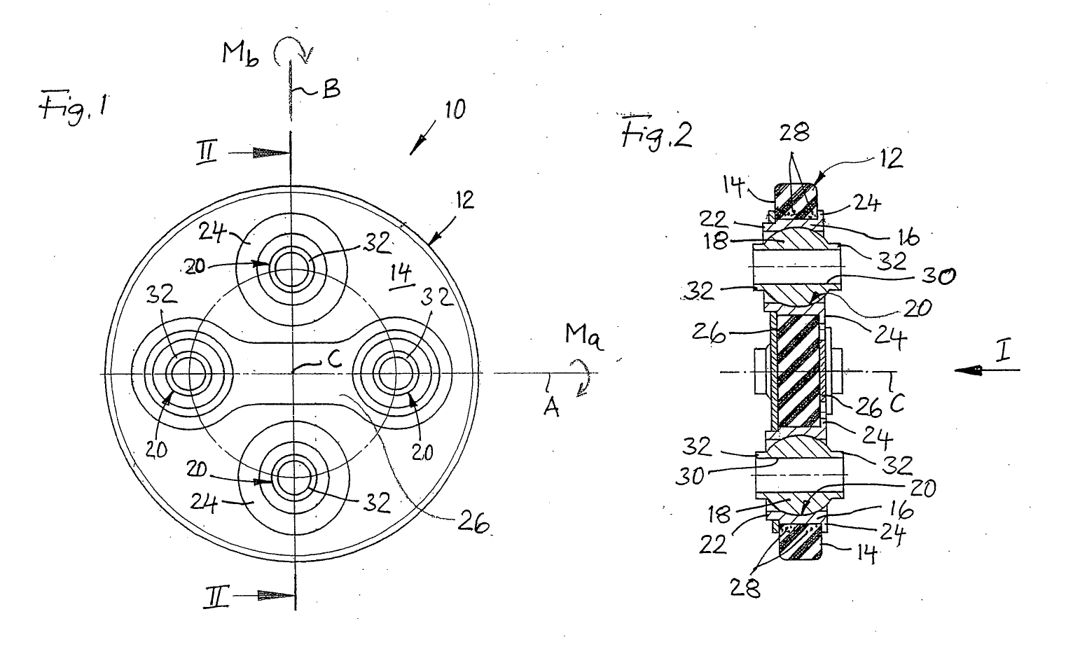

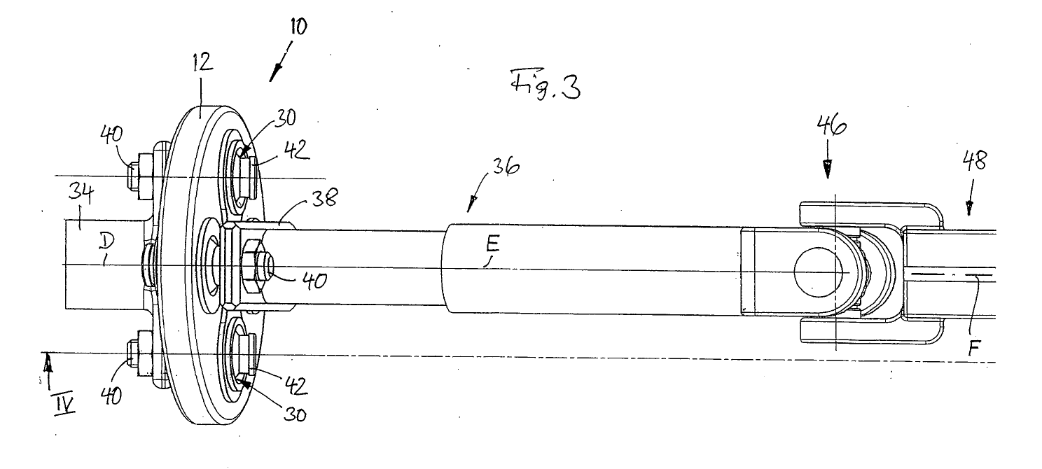

FIG. 1 is a front view of a coupling according to the invention viewed in the direction of arrow I in FIG. 2,

FIG. 2 is the cross-section II-II in FIG. 1,

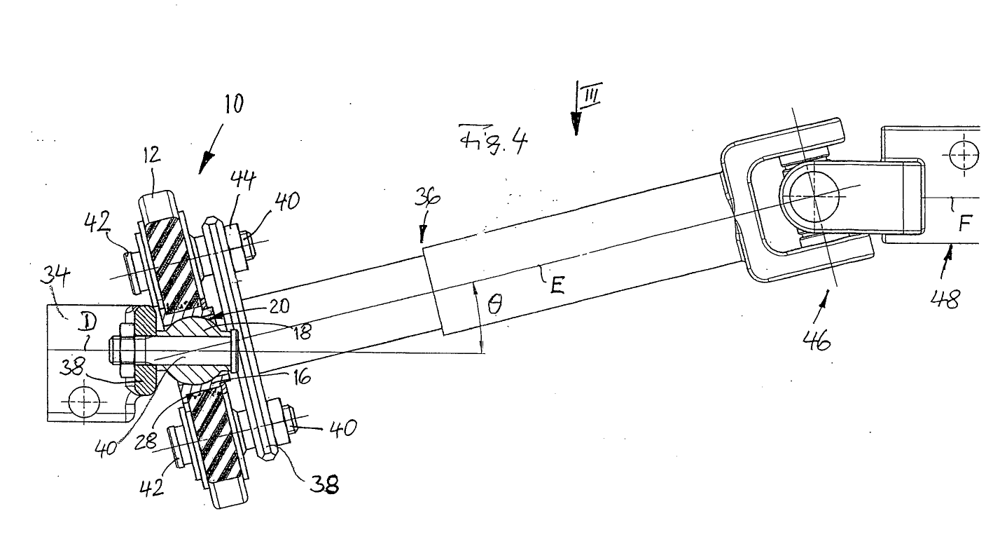

FIG. 3 is a section of a steering drive with the coupling shown in FIG. 1 and FIG. 2, shown as a view in the direction of arrow III in FIG. 4, and

FIG. 4 is the lateral view shown in partial cross-section along the plane IV-IV in FIG. 3.

The coupling 10 according to the invention shown in FIGS. 1 and 2 displays a flexible disk 12 made of rubber and is designed with mirror symmetry with regard to two axes A and B orthogonal to each other, and with axial symmetry with regard to a central axis C. The flexible disk 12 is circular and has two front faces 14 parallel to each other. Four linings 16 are embedded into the flexible disk 12 at identical intervals from the central axis C and from each other, preferably vulcanised in. Each of the linings 16 surrounds a connection body 18 and together with this forms a practically frictionless and hysteresis-free ball-and-socket joint 20. For this purpose, each of the linings 16 is designed in its axially middle range with a concave-spherical internal surface, and each of the connection bodies 18 has a convex spherical shape in its axially middle range. In the original state, before fitting the coupling 10 into a steering drive or similar, the two faces of the flexible disk 12 lie in a normal plane to their respective central axis C, and the linings 16 as well as the connection bodies 18 are arranged axially parallel to this axis C.

Each of the linings 16 has a cylindrical collar 22 at one of its ends, and at its other end a radial flange 24 jutting outwards. The two linings 16 shown in cross-section in FIG. 2 lie diametrically opposite each other in relation to the central axis C and are arranged so that their collar 22 juts out over the left front face 14 of the flexible disk 12 in FIG. 2, while their flange 24 lies on the right front face 14 of the flexible disk 12 and juts out over this to the right. The axes of these two linings 16 lie in the vertical plane B in FIG. 1. The other two linings 16 also lie diametrically opposite each other in relation to the central axis C, but their axes lie in the horizontal plane A in FIG. 1. The collars 22 of these two linings 16 point, in relation to FIG. 2, to the right, whereas their flanges 24 lie on the left front face 14 of the flexible disk 12.

Thus, the four linings 16 in total form, together with the associated connection bodies 18, two pairs of ball-and-socket joints 20 opposite each other. The linings 16 of each of these joint pairs are—independently from the other joint pair—rigidly connected to each other. For this purpose, a cross-member 26 is assigned to each of the two joint pairs. In the example shown, this is a part made of pressed steel plate, which according to FIG. 1 has the approximate shape of a link in a link chain. Each of the two cross-members 26 has two circular, rounded ends with a central circular hole. With these two holes, each of the two cross-members 26 is slipped onto the collars 22 of the two associated linings 16 and rigidly and permanently fastened, for example, pinned together. The total of four rounded ends of the two cross-members 26 delimit together with the flanges 24 of the associated linings 16 winding spaces, which contain sling packages 28. Such sling packages 28 are only indicated in FIG. 2; they connect in the usual manner each lining 16 with each of the two directly adjacent linings 16.

Each of the connection bodies 18 has a through central hole 30, which is encircled at its two end areas by a cylindrical collar 32 respectively of the connection body 18 concerned. These collars 32 serve as spacers when fitting the coupling 10 according to the invention into a drivetrain of a steering drive or similar.

According to FIGS. 3 and 4, a coupling 10 according to the invention connects a rotary body 34, whose axis is designated D, to a rotary body 36, whose axis is designated E. Each of the two rotary bodies 34 and 36 displays a yoke 38 for fixing it to the coupling 10, said yoke extending at right angles to the associated axis D or E and displaying a pair of through holes each for a fixing element 40. In the example shown, the fixing elements 40 are threaded bolts each with a flat, slotted cylindrical head 42 and a nut 40 screwed onto the opposite bolt end. However, the type of fixing elements 40 used is not important as far as the invention is concerned; for example, rivets can also be provided as fixing elements.

According to FIGS. 3 and 4, each of the total of four fixing elements 40 extends through one of the connection bodies 18 and through the associated yoke 38. In this arrangement, the yokes 38 of the rotary body 34, on the one hand, and of the rotary body 36, on the other hand, are connected to the coupling 10 according to the invention, inclined at an angle of rotation of 90 degrees in relation to each other. Alternatively, each of the connection bodies 18 can be simultaneously designed as a fixing element and, for this purpose, display an extension, for example, in the shape of a threaded bolt.

The right rotary body 36 in FIGS. 3 and 4 is a telescopic shaft; the part of it which is distant from the coupling 10 is connected by means of a cross pin joint 46 to a third rotary body 48, whose axis F is arranged parallel to axis D of the first rotary body 34 in the example shown. The axes D and E of the two rotary bodies 34 and 36 enclose an angle of inclination or bending angle of 15 degrees in the example shown; however, the non-rigid coupling 10 according to the invention permits even greater bending angles.

For cost reasons the sling packages 28 are usually wound, so that each of the linings 16 is connected to each of the two linings 16 directly adjacent by only one sling package 28, and these sling packages are arranged axially adjacent about the associated lining. When torques are transmitted across the coupling 10, this arrangement of sling packages results in the linings 16, in relation to their axial length, being asymmetrically loaded and thus being exposed to a tilting moment. Such tilting moments are each indicated in FIG. 1 with an arrow and designated as Mₐ or M_{b}. The cross-members 26 according to the invention prevent the linings 16, as a result of these moments Mₐ and M_{b}, from leaving their position parallel to the central axis C of the non-rigid coupling 10 and consequently putting an unnecessary load on the flexible disk 12. The desired flexibility of the coupling 10 according to the invention is, however, not reduced by the cross-members 26. While remaining parallel themselves, the linings 16 have a give in the peripheral direction of the coupling 10 to limits, which are determined by the hardness of the rubber in the flexible disk 12 and optionally if the sling packages 28 are pre-tensioned.

1. Non-rigid coupling (10) for the mutual connection of two rotary bodies (34,36) the axes thereof being inclined in relation to each other (D, E), with
a flexible disk (12), which is arranged between the rotary bodies (34, 36),
linings (16), embedded in the flexible disk (12) at regular intervals about a central axis (C), parallel to the same, and
connection bodies (18), that are each surrounded by one of the linings (16) and can be displaced in a limited manner in relation thereto, are fixed alternately to each of the rotary bodies (36, 38),
characterised in that
the linings (16) each form a ball-and-socket joint (20) with the associated connection bodies (18),
the flexible disk (12) contains two pairs of such diametrically opposed ball-and-socket joints (20), and
the two linings (16) of each pair of ball-and-socket joints (20) are connected to each other by means of a rigid cross-member (26).

2. Coupling according to claim 1,
characterised in that
the linings (16) each display a collar (22), to which the associated cross-member (26) is fixed.

3. Coupling according to claim 2,
characterised in that
the cross-members (26) surround the associated collars (22) in the form of a flange, and
the linings (16) each display a flange (24) turned away from its collar (22), said flange together with the flange-type area of the associated cross-member (26) delimiting a winding space for sling packages (28).

4. Coupling according to claim 1,
characterised in that
the cross-members (26) are located on each front face (14) of the flexible disk (12).

5. Coupling according to claim 4,
characterised in that
the cross members (26) are each bridged without contact by a yoke (38) of the associated rotary body (34,36).

6. Coupling according to claim 1,
characterised in that
the connection bodies (18) are generally spherical and display a central hole (30) for inserting a fixing element (40) through, said hole being surrounded at each end area by a collar (32) to axially block the associated rotary body (34, 36) or by a head (42) of the fixing element (40).
